(19) United States
(12) Patent Application Publication
(10) Pub. No.: US 2018/0215084 A1
(43) Pub. Date: Aug. 2, 2018

(54) MOLD

(71) Applicant: Kurtz GmbH, Kreuzwertheim (DE)

(72) Inventors: Maximilian Kurtz, Erlangen (DE); Norbert Reuber, Bergrothenfels (DE); Michael Ansmann, Waldaschaff (DE); Christian Kluge, Werbach (DE); Gerd Röttinger, Eichenbühl (DE)

(21) Appl. No.: 15/747,172

(22) PCT Filed: Jul. 8, 2016
(86) PCT No.: PCT/EP2016/066245

§ 371 Date: Jan. 24, 2018

(30) Foreign Application Priority Data
Jul. 24, 2015 (DE) 10 2015 112 149.2

(51) Int. Cl. B29C 44/58; B29C 33/30

(52) U.S. Cl. CPC B29C 44/588; B29C 33/301

(57) ABSTRACT

The invention relates to a mold for a device for manufacturing particle foam articles. The mold delimits a mold cavity. The mold includes a mold chase and at least one mold plate movable relative to the mold chase. The mold chase is characterized in that it comprises front walls that are formed to be more rigid than the inner wall facing the mold cavity. According to another aspect of the invention, the mold plate comprises a reinforcing structure, which is formed independently of a hollow chamber structure of the mold plate, wherein vapor is conducted exclusively through the hollow chamber structure of the mold plate. Furthermore, fins of the hollow chamber structure can be arranged slanted, so that condensed water forming in the hollow chamber structure flows away from the inner wall of the mold plate. According to another aspect, a sealing element is provided, which surrounds the mold plate. The sealing element is formed as an inflatable tube.

The present invention relates to a mold for the manufacture of particle foam articles.

WO 2013/120479 A1 discloses lightweight tools, which comprise two mold plates surrounded by a mold chase. The mold plates are formed of a multi-layer structure, which has a thin inner layer with which the mold cavity is delimited. Through the thin inner layer, the material volume subjected to the alternating thermal stress when being molded is significantly reduced. The multi-layer structure also comprises, besides the inner layer, a support layer and a carrier layer. The support layer is formed of a plurality of supporting ribs arranged perpendicular to the inner layer, which each comprise a plurality of recesses. Through the recess and the free spaces between the supporting ribs, a free fluid flow within the support layer is made possible, which is therefore also referred to as mold conducting layer. The carrier layer consists of a stable plate.

In the claims of WO 2013/120479 A1, it is also provided that the mold chase can be formed of such a multi-layer structure.

This lightweight tool has generally proven its worth as, due to the multi-layer structure, the heat capacity to be heated is significantly reduced compared to conventional tools, whereby the timing cycles can be shortened and energy can be saved.

In internal experiments, the mold chase, similar to the mold plates of the tool, was formed with a support layer, which comprises recesses and hollow spaces for conducting vapor. This layer structure also consists of a thin inner layer, a support layer and a carrier layer, which is a thick plate compared to the inner layer.

In this mold chase, there are significant problems through deformation, which occur when welding. Due to the thin sheets, post-processing is difficult as little material is at disposal. The inner layer or inner wall delimiting the mold cavity can have significant deformations.

This is extremely problematic as the mold plates are to be arranged slidably in the mold chase and the slidability is impossible due to the deformations or the sealing between the slidable mold plate and the mold chase cannot reliably be ensured. Additionally, a deformation on the inner walls of the mold chase means that the particle foam articles manufactured therewith do not have the desired shape.

Due to these problems with the multi-layer mold chase, lightweight tools have been formed with solid mold chases, as known from conventional molds. Only the mold plates are formed with the multi-layer structure.

The individual walls of the mold chases are narrow, elongated bodies, which on the one hand have to be formed with a very precise inner surface and, on the other hand, must absorb significant forces. Then again, in a mold as it is known from WO 2013/120479 A1 and which comprises a conventional mold chase, much heat is absorbed, and the advantages, which are obtained through the multi-layer mold plates, are significantly affected.

DE 20 2004 003 679 U1 demonstrates a tool for manufacturing a particle foam part which consists of two tool halves. Each tool half is provided with a slidably-arranged wall, so that a mold space can be set.

DE 15 04 494 A relates to a device for manufacturing particle foam articles with a tool, again consisting of two mold halves. In a schematic pictorial representation, the walls of the mold halves are formed with different thicknesses. As a result, the particles are heated by means of high-frequency radiation and welded together. This is why the tool is produced from a dielectric, which is transmissive to the supplied high-frequency energy.

DE 10 2008 016 883 A1 discloses a method for manufacturing a molded article made of foamed plastic material and a device for performing the method. In this tool, the air contained in the mold hollow space and in the vapor chambers is to be able to be removed by means of a water vapor purging. To that end, a vapor supply and a vacuum apparatus are provided.

The object underlying the invention is to provide a mold for manufacturing particle foam articles, which comprises a mold chase that has a low heat capacity and, on the other side, can be produced with the required precision and is mechanically stable.

The object is achieved through a mold with the features of the independent claims. Advantageous embodiments are provided in the respective dependent claims.

According to a first aspect of the invention, a mold for a device for manufacturing particle foam articles is provided, which delimits a mold cavity and comprises a mold chase and a mold plate movable relative to the mold chase. The mold chase comprises a thin inner wall delimiting the cavity and two front walls, which extend radially outward from the edge of the inner wall, wherein the front walls are formed more rigid and in particular thicker than the inner wall.

The rigid front walls provide high stability to the mold chase. The thermal connection between the rigid or thick front walls and the mold cavity is low, so that the front walls hardly affect the heat capacity of the mold chase. Hence, the front walls can be formed with per se any expedient thickness.

The front walls contribute to the fact that the deformations, that occur when welding the inner walls to the front walls, are slight as the front walls can hardly deform and therefore exactly define the location of a weld seam or a welding point, which are provided for connecting one of the front walls to the inner wall.

The inner wall and the front walls can be connected to one another by means of welding, in particular laser welding.

Preferably, the individual elements of the mold chase are connected to one another by means of laser welding, since laser welding generates a very thin weld seam which causes little deformation.

The strong front walls can be milled plane-planar on the outer surfaces thereof. The front walls can also be post-processed due to the material thickness thereof.

Preferably, a honeycomb structure for reinforcing the mold chase is arranged radially outward on the inner walls of the mold chase.

The mold can comprise two mold chases, in each of which a mold plate is arranged slidably.

The two mold chases are preferably arranged with in each case a front wall abutting, wherein one of the front walls, which are arranged facing the other mold chase, can comprise a sealing element to seal the two mold chases relative to one another.

The thin inner wall can be formed thinner or thin-walled compared to the thicker front walls.

The thin inner wall has a low heat capacity, in particular compared to the front walls, and thereby withdraws little heat from the mold cavity when heating.

The front walls have a substantially higher specific heat capacity than the inner walls. As the front walls are only coupled to the inner walls with the front faces thereof, the thermal connection to the mold cavity is low so that the heat capacity of the front walls significantly influences neither the heating nor the cooling of the mold cavity.

The thin inner wall is formed with a thickness of 3 mm at most, preferably 2.5 mm at most, and in particular 2 mm at most.

The rigid front walls have a thickness of at least 8 mm, preferably at least 9 mm and in particular at least 10 mm.

The mold chase is preferably formed of four chase parts, wherein each chase part comprises a stripe-shaped planar inner wall section.

The mold is preferably manufactured by first joining together the chase parts including in each case one of the inner wall sections, a honeycomb structure and in each case two front wall sections, and then joining together the chase parts to form the mold chase.

The individual wall parts of the mold chase can be welded together. They can also be connected to one another by means of a plug connection, wherein then corresponding sealing elements must be provided.

The surfaces of the front walls facing outward can be face-milled. In a device for manufacturing particle foam articles, for example, two mold chases are arranged between two pressing surfaces so that the mold chase have, in each case, one front wall abutting one of the two pressing surfaces and the other front wall abutting the other mold chase. Here, face-milled surfaces are advantageous as they ensure a precise orientation of the mold chases with respect to the pressing surfaces on the one hand and, on the other hand, ensure a transmission of pressure forces over the entire surface of the front wall. Furthermore, the front walls adjacent to the two mold chases abut in a planar manner so that they are well-sealed with or without a sealing element.

Preferably, the wall parts are not formed with vapor channels to supply vapor to the mold cavity. Therefore, no rear-side cover of the wall side is required, which significantly facilitates the production of the wall parts of the mold wall.

Alternatively, vapor channels can be integrated in the wall part, which in particular are lined with silicone tubes. The silicone tubes are perforated preferably on the side facing the mold cavity so that the vapor can escape into the mold cavity. The inner wall comprises corresponding through-openings here.

According to another aspect of the present invention, a mold for a device for manufacturing particle foam articles is provided, which delimits a mold cavity and comprises a mold chase and at least one mold plate movable relative to the mold chase. The mold chase is made of a thin inner wall, an adjacent hollow chamber structure in which vapor channels are formed, wherein on the side of the hollow chamber structure facing away from the inner wall a reinforcing structure is provided.

The reinforcing structure is arranged outside the hollow chamber structure. The reinforcing structure does not comprise any vapor channels. The reinforcing structure gives the mold plate a firmness, however is not heated or cooled to the extent like the hollow chamber structure in the temperature cycles. As a result, the heat capacity, which must be heated or cooled in the temperature cycles, is determined substantially only through the hollow chamber structure and the inner wall. The hollow chamber structure needs to transmit only the pressing forces from the inner wall to the reinforcing structure. The rigidity of the mold plate is caused substantially through the reinforcing structure. Therefore, the hollow chamber structure can be formed thin-walled, which again keeps the heat capacity at a low level.

The thin inner wall is formed with a thickness of 3 mm at most, preferably 2.5 mm at most, and in particular 2 mm at most.

The inner wall comprises vapor passage openings, and the vapor channels of the hollow chamber structure are provided with a port for connecting a vapor supply pipe.

The hollow chamber structure can comprise at least one port for connecting a condensate drain pipe.

According to another aspect of the invention, a mold for a device for manufacturing particle foam articles is provided. The mold delimits a mold cavity and comprises a mold chase and at least one mold plate. The mold plate has a thin inner wall and an adjacent hollow chamber structure, in which vapor channels are formed. The hollow chamber structure comprises fins extending away from the inner wall. Fins not running vertically are arranged slanted downward away from the inner wall so that condensed water accumulating on the fins flows away from the inner wall of the mold plate. This ensures that condensed water will not accumulate adjacent to the inner wall of the mold plate, which would locally cool the inner wall and would affect sintering of foam particles in the mold cavity.

Preferably, the slanted fins of the hollow chamber structure are provided with through-openings. Through-openings are arranged in particular at the regions of the fins arranged away from the inner wall, so that condensed water flows-off downward through the through-opening. The condensed water can be removed from the hollow chamber structure with a suction apparatus.

According to another aspect of the present invention, a mold for a device for manufacturing particle foam articles is provided. The mold delimits a mold cavity. The mold comprises a mold chase and a mold plate. The mold plate is arranged movable relative to the mold chase. The mold plate is provided with a circumferential sealing element to seal the mold plate against the mold chase. The sealing element is formed as an inflatable tube. For moving the mold plate, air or gas is deflated from the tube so that the mold plate is freely movable against the mold chase. If the mold plate is positioned correctly, the tube is inflated with air or another gas, whereby the mold plate is sealed against the mold chase.

The tube comprises rubber-elastic corner pieces preferably at the corner regions of the mold plate, which seal the corner regions of the mold plate against the regions of the mold chase.

According to another aspect of the present invention, a mold for a device for manufacturing particle foam articles is provided. The mold delimits a mold cavity. The mold stands out through a hollow channel formed at the inner wall on the side facing away from the mold cavity. The hollow channel is lined with a plastic material tube. In the region of the hollow channel, vapor passage openings extending through the inner wall and at the adjacent wall of the plastic material tube are formed.

The hollow channel can be formed in a mold plate and/or in a mold chase. The plastic material tube can be a silicone tube; however, other plastic materials, which are temperature-resistant, can also be used to conduct vapor.

In the above described aspects of the invention, the mold is formed of two mold chases and two movable mold plates, wherein, in each case, one mold plate is arranged in a mold chase.

Within the scope of the invention, it is also possible that at least one mold plate is fixed in place in a mold chase.

The above described aspects of the invention can be performed independently of one another, or also in combinations.

The invention is described in more detail in the following with the help of the accompanying drawings. The drawings show in:

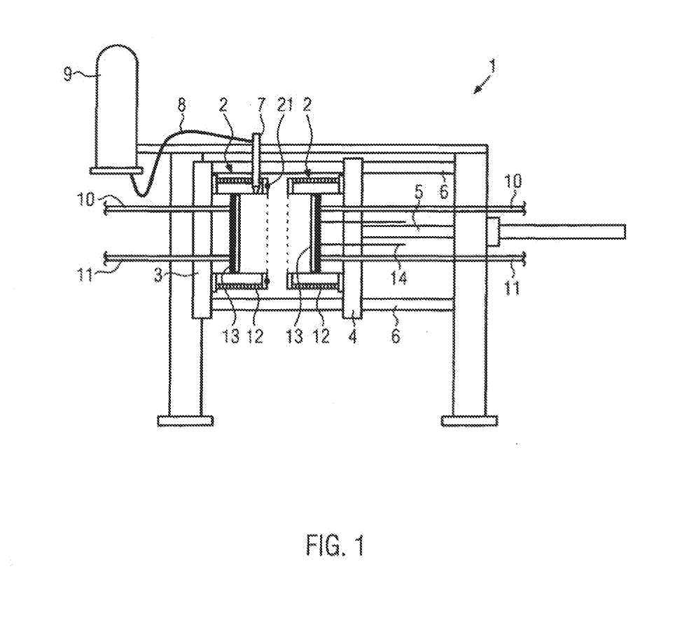

FIG. 1 schematically a device for manufacturing particle foam articles with a mold according to the invention,

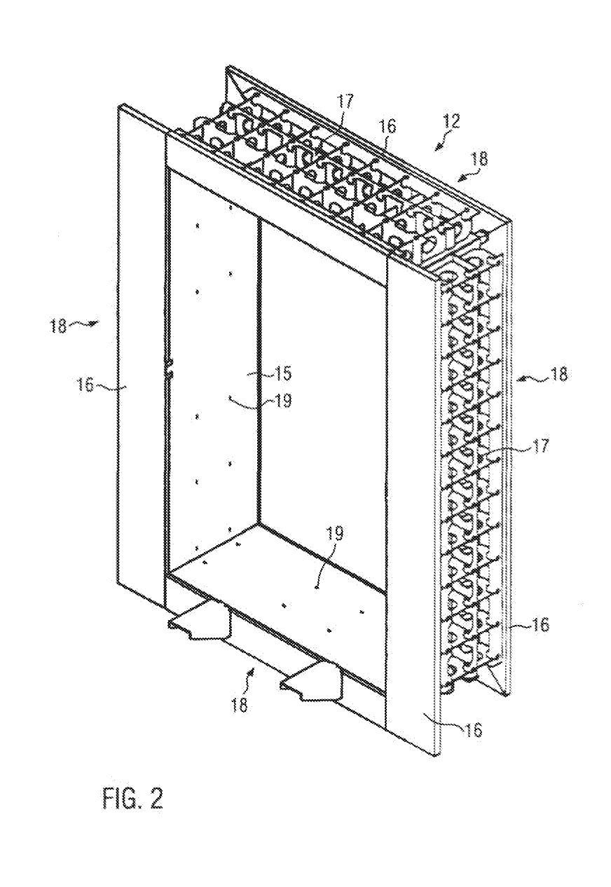

FIG. 2 a mold chase of a mold according to the invention in a perspective view,

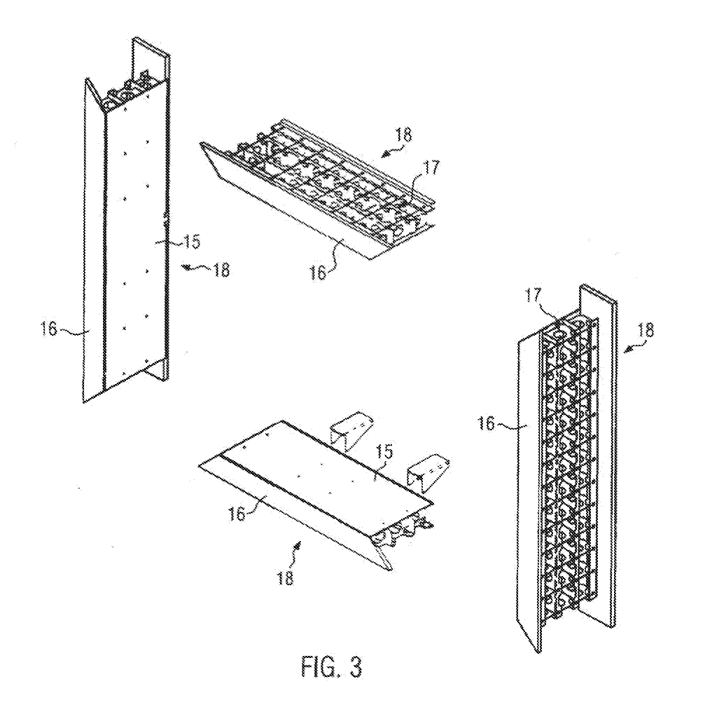

FIG. 3 the mold chase of FIG. 2, wherein individual chase parts of the mold chase are illustrated separately,

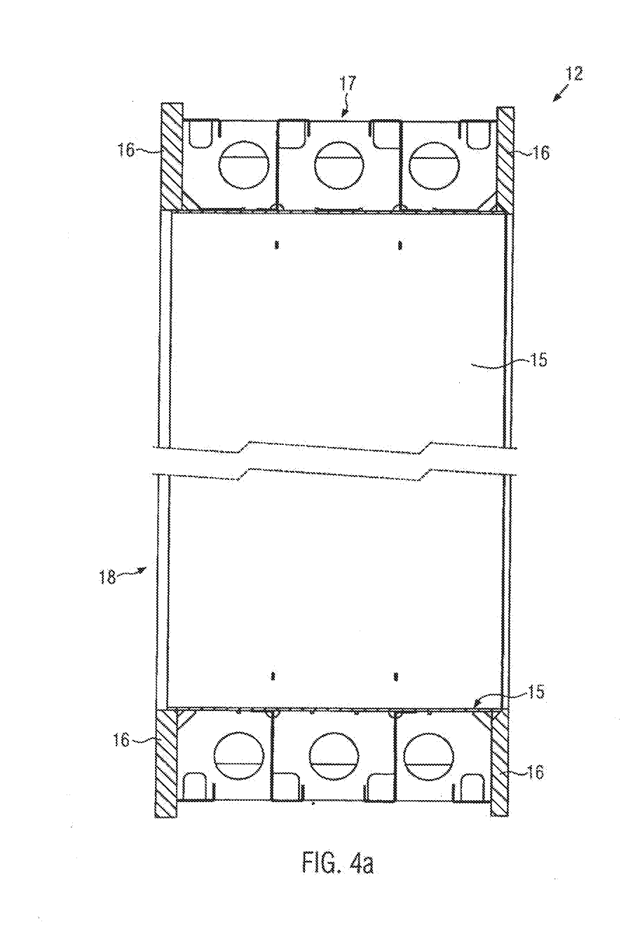

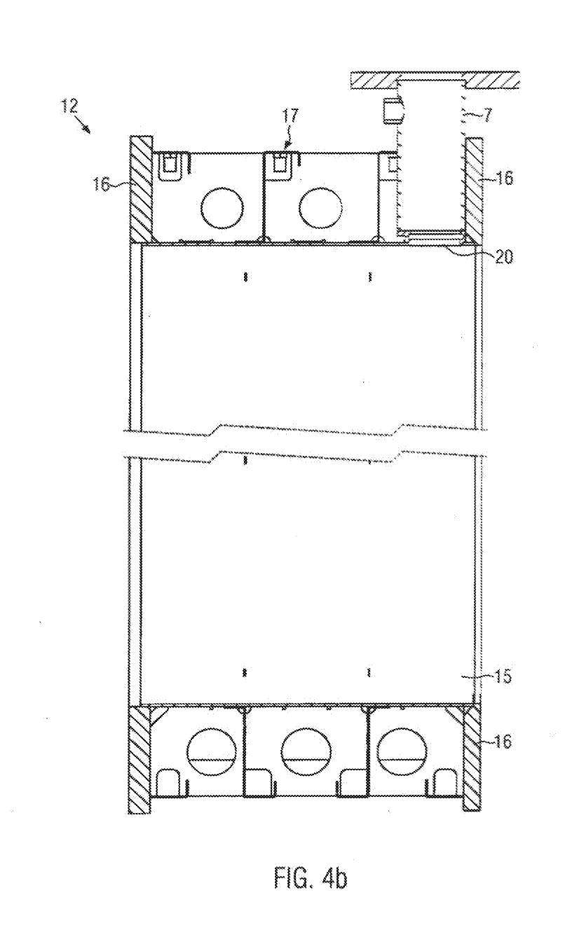

FIG. 4 the mold chase of FIG. 2 in a cross-sectional view,

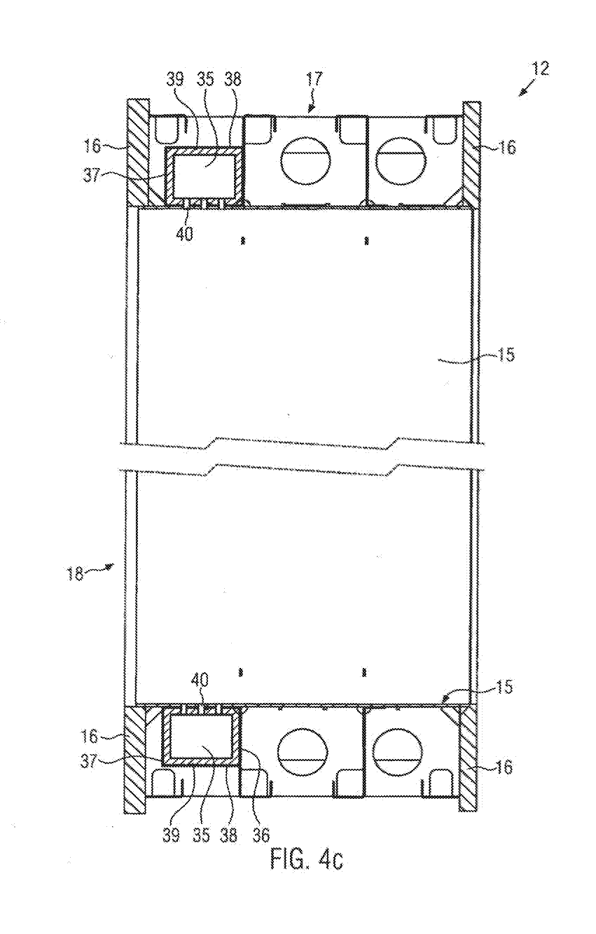

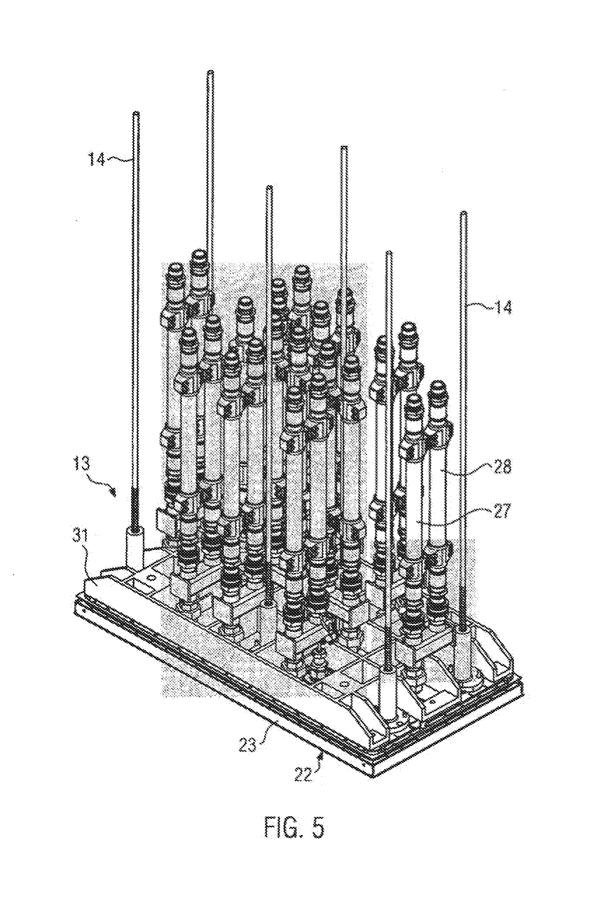

FIG. 5 a mold plate in a perspective view,

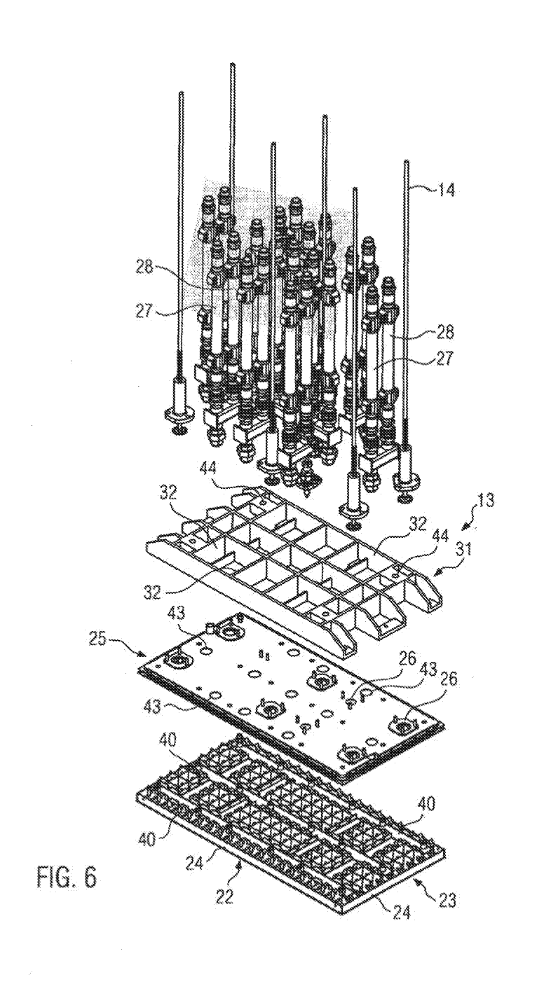

FIG. 6 the mold plate of FIG. 5 in an exploded view,

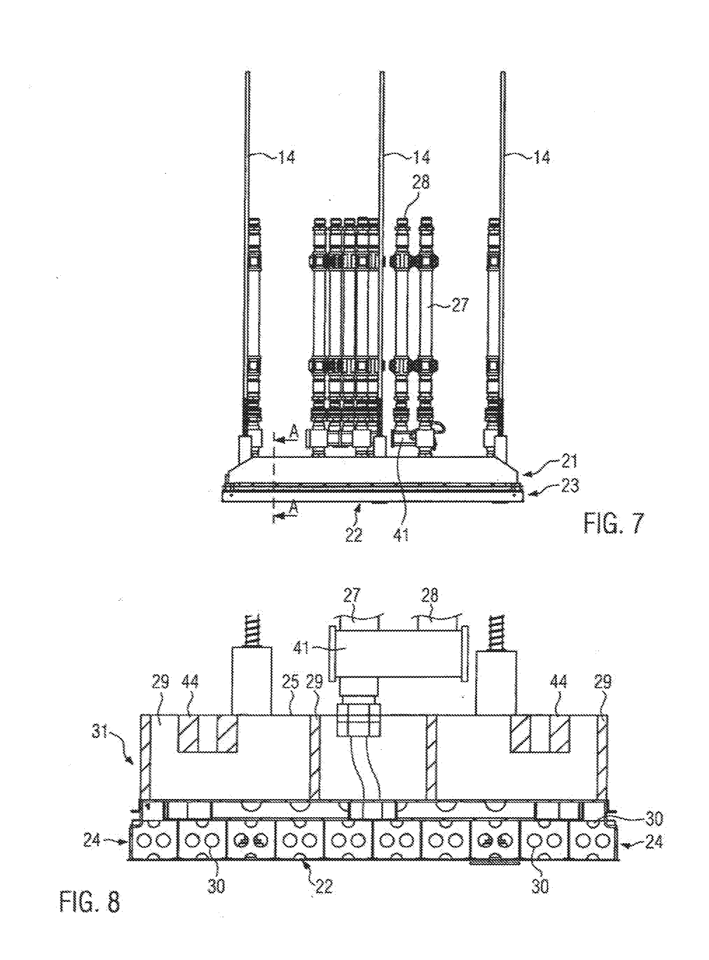

FIG. 7 the mold plate of FIG. 5 in a side view,

FIG. 8 a sectional view of the mold plate of FIG. 5 in an enlarged illustration with a thin inner wall, an adjacent hollow chamber structure as well as a reinforcing structure,

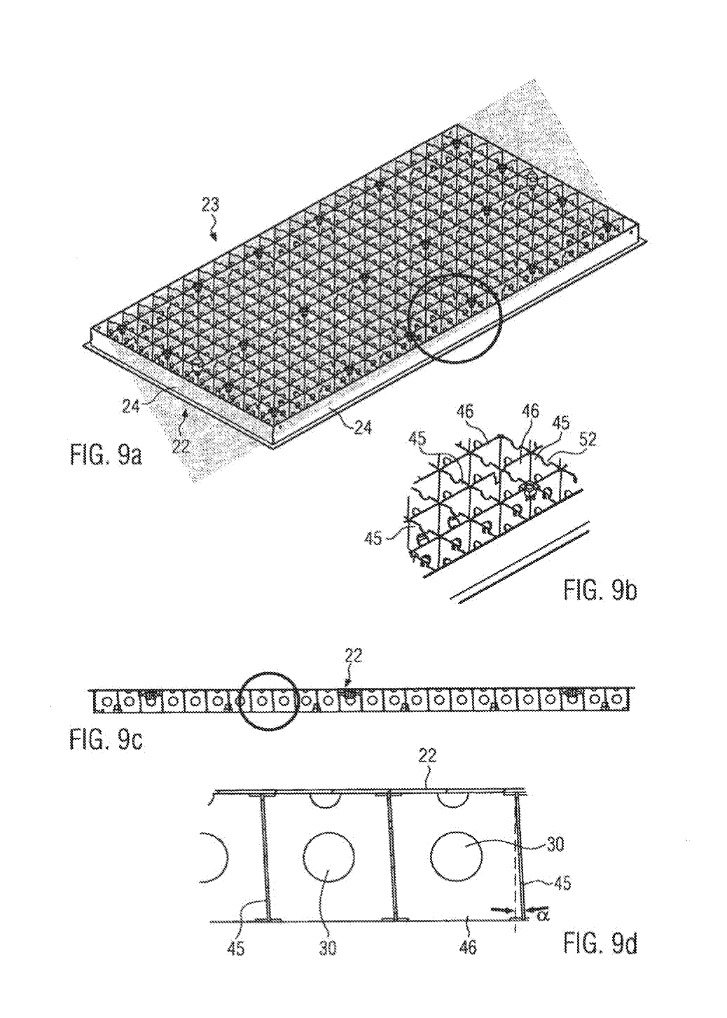

FIG. 9a-d a hollow chamber structure for a mold plate with slanted fins in different views, and

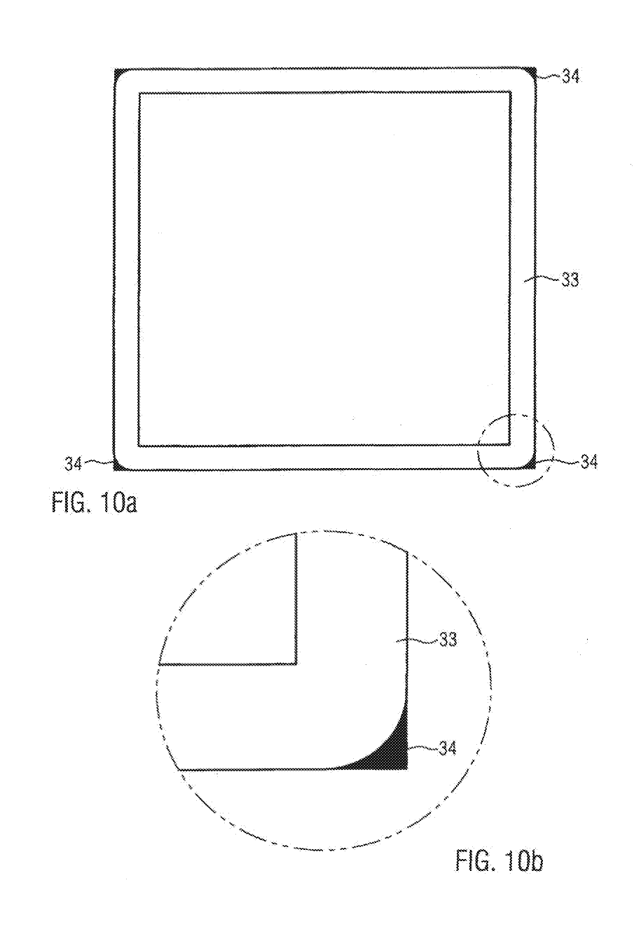

FIG. 10a, b schematically a sealing element for sealing a mold plate against a mold chase.

A device 1 for manufacturing particle foam articles usually comprises two mold halves which in each case are represented by a mold 2 (FIG. 1). The molds 2 are arranged in a pressing device with two pressing chases 3, 4 in such a way that the molds 2 are pressed together with the help of the pressing device in a closed position so that the two molds 2 together delimit a mold cavity. In an opened position (see FIG. 1), the pressing chases 3, 4 are spread apart so that the two molds 2 are spaced from one another. In the opened position, the molds 2 can be demolded from a particle foam article manufactured therein. At least one of the pressing chases 4 is supported slidably and is actuated by means of an actuating mechanism 5 which is formed as a hydraulic cylinder, for example.

The pressing chases 3, 4, the actuating mechanism 5, and guiding rods 6 for guiding the pressing chases 3, 4 are arranged in an inflexible housing chase which is formed of rigid steel supports.

At least one of the two molds 2 is provided with a filling pipe 7 which is connected to a material storage container 9 via a conduit 8. The conduit 8 is formed for supplying foam particles from the material storage container 9. The foam particles are conveyed to the filling pipe 7 with the addition of compressed air. If the material, of which the foam particles are formed, has high adhesion forces, such as e.g. expanded thermoplastic polyurethane (eTPU), then it can also be expedient to supply vapor to the conduit 8 in addition to compressed air to avoid agglutination of the foam particles on the way from the material storage container 9 to the filling pipe 7.

The two molds 2 are each provided with at least one vapor supply pipe 10 and at least one condensate drain pipe 11. The vapor supply pipes 10 are connected to a vapor generator (not shown). The condensate drain pipes 11 are connected to a vacuum pump (not shown).

The molds 2 are in each case formed of a mold chase 12 and a mold plate 13 arranged movable within the respective mold chase 12.

The mold chases 12 form a circumferential chase which, with the inner surface thereof, delimits a constant cross-sectional surface. The mold plates 13 are plates which in the plan view have approximately the shape which is delimited by the mold chase 12. At the circumference of the mold plates 13, in each case a sealing element 33 is arranged circumferentially which is formed of an inflatable tube (FIG. 10a). The inflatable tube comprises approximately triangular solid rubber parts 34 outside at the corner regions which are vulcanized on the tube (FIG. 10b). These triangular solid rubber parts 34 fill the corners of the mold chase 12 when the tube is inflated. The sealing element 33 is connected to a compressed air apparatus for automatically inflating and deflating the tube. For moving the mold plate 13 within the mold chase 12, air is deflated from the sealing tube 33 so that the mold plate 13 of the mold chase 12 is movable. If the mold plate 13 is in the desired position, then the sealing tube 33 is inflated so that it completely seals the intermediate space between the mold plate 13 and the mold chase 12.

For moving the mold plates 13 within the mold chase 12, in each case a sliding apparatus is provided. The sliding apparatuses comprise multiple push rods (not shown) which have a spindle drive to move the mold plate 13 coupled to the push rods.

The mold plates 13 are provided with spring-biased ejection rods 14. When moving back one half of the mold 2 by means of the actuating mechanism 5, the ejection rods 14 strike against a baffle plate (not shown). Thereby, the ejection rods 14 are pushed through the mold plate 13 with ends supported in the mold plate 13 and eject a particle foam article molded in the tool.

An exemplary embodiment of such a mold chase is shown in FIGS. 2 to 4b. The mold chase comprises a thin inner wall 15 which is formed with a thickness of 1 mm to 3 mm. Front walls 16 extend from the edges of the inner walls radially outward. The front walls 16 are formed more rigid than the inner walls. In the present exemplary embodiment, the front walls 16 have a thickness of 10 to 12 mm. A honeycomb structure 17 is located in the region between the front walls 16 and radially adjacent outward on the inner wall 15. In the present exemplary embodiment, the honeycomb structure 17 comprises rectangular honeycombs which are formed of thin-walled sheet stripes running orthogonally to one another.

The mold chase 12 has a rectangular shape in the front view which is formed of four chase parts 18. Each chase part is formed of a stripe-shaped planar inner wall section, two front wall sections and a corresponding section of the honeycomb structure (FIG. 3).

The inner wall 15 has small holes 19 into which positioning plugs molded to the honeycomb structure 17 are inserted. The honeycomb structure 17 thus is connected to the inner wall 15 with a plug connection.

When manufacturing the mold chase 12, first the individual chase parts 18 are separately joined together from the respective inner wall sections, the sections of the honeycomb structure and the front wall sections. The individual elements can be welded to one another. Preferably, they are connected to one another through individual welding points.

The individual chase parts 18 are separately adjusted then. Only then, they are joined together and connected to one another. Preferably, they are connected to one another through welding. In particular, laser welding is suitable as a laser welding seam is very thin and causes little deformation.

As the front walls 16 are formed of rigid sheet stripes, in particular steel sheet stripes, they contribute substantially to the stability of the entire mold chase 12. In particular, they prevent that the chase parts 18 deform during production or that the entire mold chase 12 deforms. At least they ensure that the deformations are little so that they can be adjusted after joining together the individual chase parts 18 to the mold chase 12. Due to the thickness of the front walls 16, it is possible to face-mill the walls and thus align the surfaces of the front walls precisely perpendicular to one another with respect to the inner surfaces of the inner walls.

The mold chases 12 according to this exemplary embodiment has no vapor channels for supplying vapor to the mold cavity. This substantially facilitates the production of the mold chase 12 and reduces the risk of deformations as no sealed chambers for delimiting the vapor channel are required.

FIG. 4a shows an embodiment of the mold chase in cross section which comprises no filling pipe. FIG. 4b shows a similar cross-sectional view of another embodiment of the mold chase which is provided with a filling pipe 7 which can be connected to the material storage container 9 via a conduit 8. The filling pipe 7 opens out through a corresponding opening 20 on the inner wall 15 at the inner region of the mold chase 12 with which a section of the mold cavity is delimited.

The inner wall 15 formed thin-walled delimits a section of the mold cavity. The inner wall has a low heat capacity compared to a thick wall and thereby withdraws heat from the mold cavity when heating.

The front walls 16 have a substantially higher specific heat capacity than the inner wall 15. As the front walls 16 are only coupled to the inner wall 15 with the front faces thereof, the thermal connection to the mold cavity is little so that the heat capacity of the front walls 16 significantly affect neither the heating nor the cooling of the mold cavity.

Due to the high rigidity of the front walls 16, the mold chase 12 has a high rigidity which reduces the risk of a deformation. Additionally, with only slight deformations through face-milling or face-grinding of the surfaces of the front walls 16, the outer surfaces of the front walls 16 as well as the inner surface of the inner wall 15 can be aligned precisely orthogonal to one another. This allows correcting of the surfaces after the final joining together of all elements of the mold chase 12.

The relatively thick front walls 15 allow also introducing a groove (not shown) for receiving a sealing element. It can be expedient to provide a circumferential sealing element 21 (FIG. 1) on at least one of the two front walls which abut in the closed state of the mold 2. The sealing element is preferably a silicone sealing.

A further exemplary embodiment of a mold chase 12 (FIG. 4c) is provided with a circumferential vapor channel 35. For the rest, the mold chase 12 is formed in the same way as the above-described mold chase 12. The vapor channel 35 is delimited through the inner wall 15, a sheet stripe or a fin 36 of the honeycomb structure and two additionally arranged sheet stripes 37, 38. The sheet stripes 37, 38 are fixed to the inner wall 15 or the fin 36 and to one another with only a few welding points. The channel delimited thereby is not sealed, which is why a tube-shaped silicone lining 39 sealing the vapor channel 35 is located on the inner surface of the sheet stripes 37, 38, the fin 36 of the inner wall 15 which delimit the vapor channel. In the silicone lining 39 aligning through-openings 40 are formed at the section abutting the inner wall 15 and at the inner wall 15 per se, through which vapor can exit from the vapor channel 35 into the mold cavity delimited through the mold chase 12.

The silicone lining 39 allows to connect the metal parts 15, 36, 37 and 39 in a not-sealed manner as an unintentional exiting of the vapor from the vapor channel 35 is reliably prevented due to the silicone lining 39. A not-sealed connection of the metal parts 15, 36, 37, 38 requires only few little welding points which do not cause deformation on the mold chase 12.

The mold plate 13 (FIG. 5 to FIG. 8) comprises a thin inner wall 22. The inner wall is formed with a thickness of 1 to 3 mm. Outside on the inner wall 22, a hollow chamber structure 23 is formed. The hollow chamber structure 23 comprises, similar to the honeycomb structure 17 of the mold chase 12, rectangular honeycombs formed by means of thin-walled, stripe-shaped sheets. However, the hollow chamber structure 23 is substantially sealed in a gas-tight manner with a circumferential side wall 24 on the front face and a rear wall 25 arranged on the opposite side to the inner wall 22. In the present exemplary embodiment, the rear wall 25 in the circumferential region of the hollow chamber structure 23 extends a bit in the direction to the inner wall 22. In the same way, it is also possible that the side wall 24 extends over the entire height of the hollow chamber structure 23 or a bit inward over the rearward region. Substantially gas-tight means that the hollow chamber structure is formed not absolutely sealed, because the inner wall 22 of the mold plate 13 comprises vapor passage openings so that vapor can be introduced into the mold cavity from the hollow chamber structure 23 through the inner wall 22. Furthermore, the rear wall 25 comprises ports 26 for connecting vapor supply pipes 27 and condensate drain pipes 28.

In the sheet stripes 29, which delimit the honeycombs of the hollow chamber structure 23, through-openings 30 are provided so that multiple honeycombs are connected to vapor channels along which the vapor supplied via the vapor supply pipes 27 can spread in the hollow chamber structure 23. In the exemplary embodiment shown in FIG. 6, free channels 40 are formed in the hollow chamber structure 23 which are free from sheet stripes of the hollow chamber structure 23. The free channels 40 extend over almost the entire longitudinal direction and almost the entire transversal direction of the mold plate 13. The vapor supply pipes 27 and the condensate drain pipes 28 open out directly at the free channels 40. In the exemplary embodiment, in each case a vapor supply pipe 27 and a condensate drain pipe 28 is connected to a common connection piece 40 from which a short pipe section 42 leads to in each case an opening 43 of the rear wall 25. The openings 43 are arranged adjacent to the free channels 40.

The hollow chamber structure 23 is formed substantially of thin-walled sheets, wherein the rear wall 25, the side wall 24, the inner wall 22 and the sheet stripes 29 have a thickness of not more than 3 mm, preferably not more than 2.5 mm and in particular not more than 2 mm.

The height of the hollow chamber structure 23, i.e. the distance between the inner wall 22 and the rear wall 25 is not more than 5 cm, preferably not more than 4 cm and in particular not more than 3 cm.

The hollow chamber structure 23 thus is a relatively thin honeycomb element which per se has no high inherent rigidity. Therefore, a reinforcing structure 31 is arranged on the side of the hollow chamber structure 23 facing away from the inner wall 22. The reinforcing structure 31 is a framework of thick sheet stripes 32 which are arranged running longitudinally and transversally to one another so that they form a rectangular grid. The individual sheet stripes are arranged perpendicular to the plane of the inner wall 22. The sheet stripes running longitudinally and transversally are connected to one another through welding or soldering so that they form an integral reinforcing structure 31. The perpendicular arrangement of the sheet stripes 32 with respect to the inner wall 22 or the rear wall 25 effects on the one hand a high bending rigidity against a sagging of the hollow chamber structure 23 transversal to the plane of the inner wall 22 and on the other hand the sheet stripes 32 only abut the rear wall 25 with the front faces so that the contact surface and thus the heat transmission from the rear wall 25 to the reinforcing structure 31 is very small.

In the present exemplary embodiment, the mold plate 13 extends over a surface of, e.g. 60 cm×120 cm or 50 cm×100 cm or 60 cm y 125 cm. With this size of the mold plate 13, the weight of the reinforcing structure 31 is about 25 kg. The weight of the hollow chamber structure 23 including the rear wall 25 and the inner wall 22 is about 5 kg. As only the weight of the hollow chamber structure 23 is heated or cooled through the supplied vapor during the heat cycles, the impairment due to the heat capacity of the mold plate 13 is very low. Then again, a highly-rigid reinforcing structure 31 is provided which is substantially not heated and cooled during the heat cycles. The mold plate 13 thus has a high stability on the one hand and on the other hand only a low heat capacity which comes into contact with the supplied vapor.

The hollow chamber structure 23 therefore has preferably a weight that is not more than 30%, in particular not more than 20%, and preferably not more than 15%, of the weight of the entire mold plate 13 including the reinforcing structure.

Furthermore, fastening points 44 for fastening the push rods are provided at the reinforcing structure 31. Four fastening points 44 are arranged in the corner regions of the reinforcing structure 31.

The FIGS. 9a to 9d show another embodiment of the hollow chamber structure 23 of the mold plate 13. The hollow chamber structure 23 is formed honeycomb-like of horizontal sheet stripes or fins 45 and vertical sheet stripes or fins 46. The horizontal fins 45 are arranged slanted by the angle α (FIG. 9d) opposite to a plane standing perpendicular on the inner wall 22. The slanting is formed in such a way that the horizontal fins 45 of the inner wall 22 of the mold plate 13 hang a little downward. Thereby, water which is generated through condensing of vapor in the hollow chamber structure 23 is conducted away from the inner wall 22 of the mold plate 13. Cutaways 47 (FIG. 9b) are formed on the edge of the horizontal fins 45 spaced from the inner wall 22. Water forming through condensing of water vapor in the hollow chamber structure 23 is conducted away from the inner wall 22 of the mold plate 13 due to the slanting of the horizontal fins 45 and passes through the cutaways 47 or other openings 30 in the horizontal fins 45 into the lower region of the mold plate 13.

At least here, a suction apparatus with a vacuum pump is provided to drain the condensed water from the mold plate 13. With this slanted arrangement of the horizontal fins 45, condensed water is prevented from accumulating not adjacent to the inner wall 22 of the mold plate 13. This would lead to the inner wall 22 being significantly cooled on the regions to which the condensed water abuts, and the welding or sintering of the foam particles present in the mold cavity cannot reliably be carried out. Further suction apparatuses can, of course, also be provided at other positions of the mold plate 13.

Reference characters

```
  1 Device for manufacturing particle foam articles
  2 Mold
  3 Pressing chase
  4 Pressing chase
  5 Actuating mechanism
  6 Guiding rod
  7 Filling pipe
  8 Conduit
  9 Material storage container
10 Vapor supply pipe
11 Condensate drain pipe
12 Mold chase
13 Mold plate
14 Ejection rod
15 Inner wall
16 Front wall
17 Honeycomb structure
18 Chase part
19 Hole
20 Opening
21 Sealing element
22 Inner wall
23 Hollow chamber structure
24 Side wall
25 Rear wall
26 Port
27 Vapor supply pipe
28 Condensate drain pipe
29 Sheet stripe
30 Through-opening
31 Reinforcing structure
32 Sheet stripe
33 Sealing element
34 Corner sealing part
35 Vapor channel
36 Fin
37 Sheet stripe
38 Sheet stripe
39 Silicone lining
40 Free channel
41 Connection piece
42 Conduit section
43 Opening
44 Fastening point
45 Horizontal fin
46 Vertical fin
47 Cutaway
```

1. Mold for a device for manufacturing particle foam articles, which delimits a mold cavity and comprises a mold chase and at least one mold plate movable relative to the mold chase, wherein the mold chase (12) comprises a thin inner wall delimiting the mold cavity and two front walls, which extend radially outward from the edge of the inner wall, wherein the front walls are formed to be more rigid than the inner wall.

2. Mold according to claim 1,
wherein a honeycomb structure for reinforcing the mold chase is arranged radially outward on the inner walls of the mold chase.

3. Mold according to claim 1,
wherein the mold comprises two mold chases, in each of which a mold plate is slidably arranged.

4. Mold according to claim 3,
wherein the two mold chases are arranged with in each case one front wall abutting, wherein one of the front walls, which faces the other mold chase, comprises a sealing element to seal the two mold chases relative to one another.

5. Mold according to claim 1,
wherein the inner walls have a thickness of 3 mm at most, or of 2.5 mm at most, or of 2 mm at most.

6. Mold according to claim 1,
wherein the front walls have a thickness of at least 8 mm.

7. Mold according to claim 1,
wherein the mold chase is formed of four chase parts, wherein each chase part comprises a stripe-shaped, planar inner wall section.

8. Mold according to claim 7,
wherein the mold is manufactured by first joining the chase parts including in each case one of the inner wall sections, a honeycomb structure and in each case two front wall sections, and then joining the chase parts to form the mold chase.

9. Mold according to claim 1,
wherein the surfaces of the front walls facing outward are face-milled.

10. Mold according to claim 1,
wherein the inner wall and the front wall are connected to one another by means of welding, in particular by means of laser welding.

11. Mold for a device for manufacturing particle foam articles, wherein the mold delimits a mold cavity and comprises a mold chase and at least one mold plate movable relative to the mold chase, and the mold plate comprises a thin inner wall and an adjacent hollow chamber structure, in which vapor channels are formed, wherein a reinforcing structure is provided on the side of the hollow chamber structure facing away from the inner wall.

12. Mold for a device for manufacturing particle foam articles, wherein the mold delimits a mold cavity and comprises a mold chase and at least one mold plate, and the mold plate comprises a thin inner wall and an adjacent hollow chamber structure, in which vapor channels are formed, wherein the hollow chamber structure comprises fins, which extend away from the inner wall, and fins not running vertically are arranged slanted downward away from the inner wall, so that condensed water accumulating on the fins flows away from the inner wall.

13. Mold according to claim 12,
wherein the slanted fins of the hollow chamber structure comprise through-openings which are arranged away from the inner wall so that condensed water flows off downward through the through-openings.

14. Mold according to claim 12,
wherein a suction apparatus for suctioning condensed water from the hollow chamber structure is provided.

15. Mold according to claim 11,
wherein the inner wall comprises vapor passage openings.

16. Mold according to claim 11,
wherein the hollow chamber structure is provided with at least one port for connecting a vapor supply pipe.

17. Mold for a device for manufacturing particle foam articles, wherein the mold delimits a mold cavity and comprises a mold chase and at least one mold plate movable relative to the mold chase,
wherein the mold plate comprises a circumferential sealing element to seal the mold plate against the mold chase, and
the sealing element is an inflatable tube.

18. Mold according to claim 17,
wherein the tube is connected to a compressed air apparatus to automatically inflate and deflate the tube.

19. Mold according to claim 17,
wherein the tube is provided with multiple rubber-elastic corner pieces to seal the mold plate at corner regions of the mold chase.

20. Mold for a device for manufacturing particle foam articles, wherein the mold delimits a mold cavity, and the mold comprises a thin inner wall delimiting the mold cavity,
wherein a hollow channel is formed on the inner wall at the side facing away from the mold cavity and the hollow channel is lined with a plastic tube, wherein vapor passage openings extending through the inner wall and an adjacent wall of the plastic tube are formed in the region of the hollow channels.
